(19) United States
(12) Patent Application Publication
(10) Pub. No.: US 2006/0273911 A1
(43) Pub. Date: Dec. 7, 2006

(54) Radio communication system, antenna device and sheet processing device

(75) Inventor: Atsushi Nakagawa, Kawasaki-shi (JP)

Correspondence Address: PILLSBURY WINTHROP SHAW PITTMAN, LLP, P.O. BOX 10500, MCLEAN, VA, 22102, US

(73) Assignee: Kabushiki Kaisha Toshiba, Tokyo (JP)

(21) Appl. No.: 11/375,048

(22) Filed: Mar. 15, 2006

(30) Foreign Application Priority Data
Jun. 7, 2005 (JP) 2005-166961
Aug. 25, 2005 (JP) 2005-244526

(51) Int. Cl. G08B 13/14

(52) U.S. Cl. 340/572.7; 340/10.1

(57) ABSTRACT

A radio communication system includes an antenna device, and transmits and receives data by radio to and from a radio communication medium. The antenna includes two transmission lines provided along the conveyance path, and generates a magnetic field between the transmission lines perpendicularly with respect to the surface of the radio communication medium conveyed. Accordingly, when the radio communication medium is conveyed between the two transmission lines, it passes through a uniform magnetic field generated over a relatively long distance, over which the transmission lines run. As a result, stable communication can be established over the relatively long distance.

### CROSS-REFERENCE TO RELATED APPLICATIONS

This application is based upon and claims the benefit of priority from prior Japanese Patent Applications No. 2005-166961, filed Jun. 7, 2005; and No. 2005-244526, filed Aug. 25, 2005, the entire contents of both of which are incorporated herein by reference.

### BACKGROUND OF THE INVENTION

1. Field of the Invention

The present invention relates to a radio communication system for communicating by radio with a radio communication medium, an antenna device incorporated in the radio communication system, and a sheet processing device for communicating by radio with a radio communication medium incorporated in a sheet conveyed at a relatively high speed, thereby processing the sheet based on the communication result.

2. Description of the Related Art

FIG. 17 schematically shows such a radio communication system as employed in the sheet processing device disclosed in, for example, Jpn. Pat. Appln. KOKAI Publication No. 2003-296786. As shown, the radio communication system communicates by radio with a radio communication medium 10 incorporated in a sheet conveyed at a relatively high speed.

The radio communication medium 10 is, for example, an RF ID tag, and conveyed by a conveyance path 7 at a speed v [m/s] in the direction indicated by arrow T. Actually, the radio communication medium 10 is conveyed, incorporated in a sheet (not shown), such as a bank bill or mail article. An antenna device 21 connected for communication to the main unit 20 of the radio communication system is provided along the conveyance path 7.

When the radio communication medium 10 conveyed on the path 7 enters the communication area 8 of the main unit 20 (antenna device 21), it receives the electromagnetic radiation emitted from the antenna device 21. When the power of the radiation reaches a value that can operate the radio communication medium 10, the medium 10 can receive a polling request from the main unit 20.

As shown in FIG. 18, the main unit 20 transmits a polling request (radio communication signal) at regular intervals. Upon receiving the polling request, the radio communication medium 10 transmits a response signal. When receiving the response signal, the main unit 20 completes the communication and resumes the transmission of a polling request at regular intervals.

Where the above radio communication system is incorporated in the sheet processing device that continuously processes, at a high speed, sheets with the radio communication medium 10 incorporated therein, to read data from the medium 10, a countermeasure for reliably performing communication is needed. For instance, it is necessary to increase the size of the antenna device of the radio communication system, or to provide a plurality of antenna devices along the conveyance path of the sheets and sequentially switch the antenna devices in accordance with respective sheets entering the communication areas of the antenna devices. Such prior art is disclosed in, for example, Jpn. Pat. Appln. KOKAI Publication No. 2000-105800 or 2002-216092.

However, when accessing a microminiature radio communication medium with a microminiature antenna that is expected to become prevailing henceforth, it is difficult for the above-described prior art to supply uniform power to the medium over a relatively long distance in the moving direction of the medium. Accordingly, a communication error, in which the radio communication system cannot access the radio communication medium moving in the communication area, may well occur.

Furthermore, if the antenna device of the radio communication system is formed of, for example, a printed circuit board as in the prior art, it is difficult to incorporate the antenna device into a conveyance path for conveying sheets since the path has a complex structure including a conveyance belt and rollers, etc.

### BRIEF SUMMARY OF THE INVENTION

It is an object of the invention to provide a radio communication system, antenna device and sheet processing device capable of reliably accessing a radio communication medium, conveyed at a relatively high speed, over a relatively long distance in the movement direction of the medium.

It is another object of the invention to provide a radio communication system, antenna device and sheet processing device that enable the antenna device to be positioned in accordance with the configuration of a conveyance path for conveying a radio communication medium.

To attain the objects, in accordance with an embodiment of the invention, there is provided a radio communication system including: an antenna device which generates a magnetic field to a radio communication medium conveyed through a conveyance path, the magnetic field passing through the radio communication medium; and a main unit which transmits and receives signals via the antenna device to and from the radio communication medium conveyed through the conveyance path, thereby performing communication with the radio communication medium, and wherein the antenna device comprises a plurality of transmission lines provided parallel to each other along the conveyance path, and a signal circuit which divides, into a plurality of components, a signal from the main unit, shifts phases of the components from each other, and supplies the resultant components to the respective transmission lines.

In accordance with another embodiment of the invention, there is provided an antenna device for a radio communication system which performs radio communication by transmitting and receiving signals to and from a radio communication medium conveyed through a conveyance path, comprising: a plurality of transmission lines provided parallel to each other along the conveyance path; and a signal circuit which divides, into a plurality of components, a signal from the main unit, shifts phases of the components from each other, and supplies the resultant components to the respective transmission lines.

In accordance with yet another embodiment of the invention, there is provided a sheet processing apparatus for conveying a sheet provided with a radio communication medium storing identification data, reading the identification data from the radio communication medium, and processing the sheet based on the read identification data, comprising: an antenna device which generates a magnetic field to a radio communication medium conveyed through a conveyance path, the magnetic field passing through the radio communication medium; and a main unit which transmits and receives signals via the antenna device to and from the radio communication medium conveyed through the conveyance path, thereby performing communication with the radio communication medium, wherein the antenna device comprises a plurality of transmission lines provided parallel to each other along the conveyance path, and a signal circuit which divides, into a plurality of components, a signal from the main unit, shifts phases of the components from each other, and supplies the resultant components to the respective transmission lines.

Additional objects and advantages of the invention will be set forth in the description which follows, and in part will be obvious from the description, or may be leaned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 is a schematic block diagram illustrating the configuration of a sheet processing device according to the invention;

FIG. 2A is a schematic view illustrating an example of a radio communication medium processed by the device of FIG. 1;

FIG. 2B is a schematic view illustrating another example of the radio communication medium processed by the device of FIG. 1;

FIG. 3A is a schematic perspective view illustrating the structure of an antenna device according to a first embodiment of the invention;

FIG. 3B is a circuit diagram illustrating the antenna device of FIG. 3A;

FIG. 4 is a view useful in explaining the operation of the antenna device of FIG. 3S;

FIG. 5A is a schematic perspective view illustrating the structure of an antenna device according to a second embodiment of the invention;

FIG. 5B is a view illustrating a state in which the antenna device of FIG. 5A is angled;

FIG. 5C is a schematic view illustrating a state in which the antenna device of FIG. 5A is incorporated into a sheet processing device;

FIG. 5D is a sectional view useful in explaining the positional relationship between conveyance belts and the antenna device;

FIGS. 6A and 6B are views useful in explaining other ways of arrangement of the antenna device of FIG. 5A;

FIG. 7A is a schematic view illustrating conveyance belts that define a conveyance path for conveying the radio communication medium;

FIG. 7B is a schematic perspective view illustrating an antenna device according to a third embodiment of the invention, in which the conveyance belts of FIG. 7A are used to form a transmission path;

FIG. 7C is a schematic view useful in explaining an example of a power supply method for supplying power to the conveyance belt of FIG. 7B;

FIG. 8 is a schematic view useful in explaining the operation of the antenna device of FIG. 7B;

FIG. 9A is a schematic perspective view illustrating the structure of an antenna device according to a fourth embodiment of the invention;

FIG. 9B is a schematic view illustrating a state in which the antenna device of FIG. 9A is incorporated in a sheet processing device;

FIG. 9C is a sectional view illustrating an example of arrangement of the antenna device with respect to the conveyance belts;

FIG. 9D is a sectional view illustrating another example of arrangement of the antenna device with respect to the conveyance belts;

FIG. 10 is a schematic view useful in explaining the operation of the antenna device FIG. 9A;

FIG. 11A is a schematic view illustrating an antenna device according to a fifth embodiment of the invention;

FIG. 11B is a view useful in explaining the circuitry of the antenna device of FIG. 11A;

FIG. 12 is a view useful in explaining the operation of the antenna device of FIG. 11A;

FIG. 13A is a view illustrating a state in which the radio communication medium is attached to a peripheral portion of a sheet;

FIG. 13B is a view illustrating a state in which the radio communication medium is attached to another peripheral portion of the sheet;

FIG. 13C is a schematic view illustrating an antenna device according to a sixth embodiment of the invention;

FIG. 14 is a schematic view illustrating an antenna device according to a seventh embodiment of the invention;

FIG. 15 is a schematic view useful in explaining the feeder structure of the antenna device of FIG. 14;

FIG. 16A is a circuit diagram useful in explaining the coupling structure of the signal-input side of the antenna device shown in FIG. 15;

FIG. 16B is a circuit diagram useful in explaining the coupling structure of the terminal side of the antenna device shown in FIG. 15;

FIG. 17 is a schematic view useful in explaining the operation of a conventional antenna device; and

FIG. 18 is a timing chart useful in explaining the polling-command-output timing of a conventional radio communication system.

### DETAILED DESCRIPTION OF THE INVENTION

Embodiments of the invention will be described with reference to the accompanying drawings.

A description will be given of the case where a radio communication medium attached to a sheet (not shown) does not have a built-in battery, and performs communication processing using electromagnetic radiation of 2.45 GHz emitted from a radio communication system.

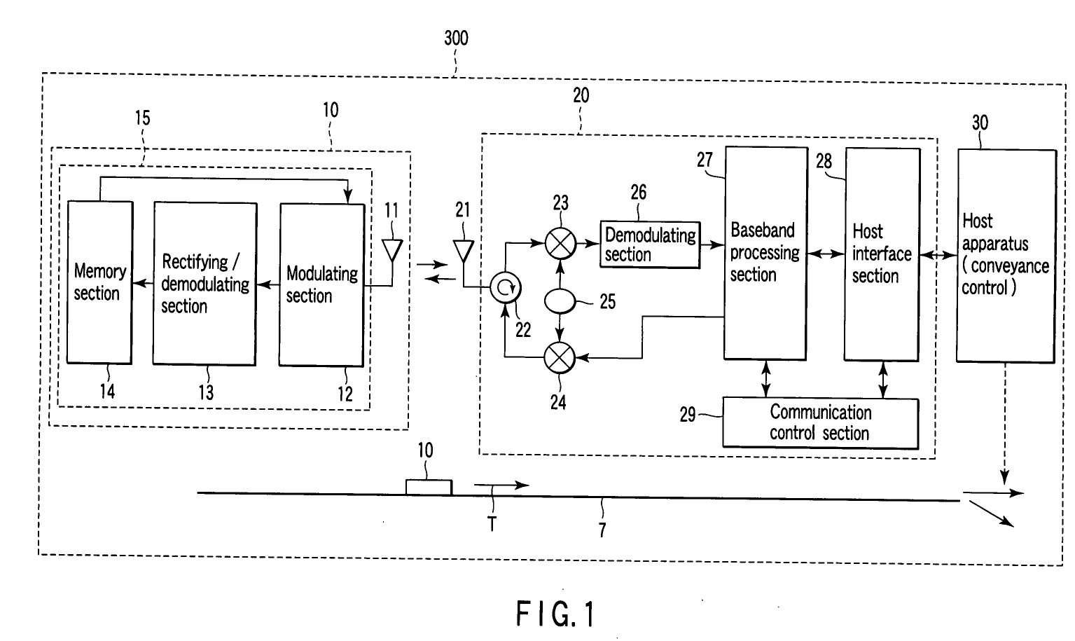

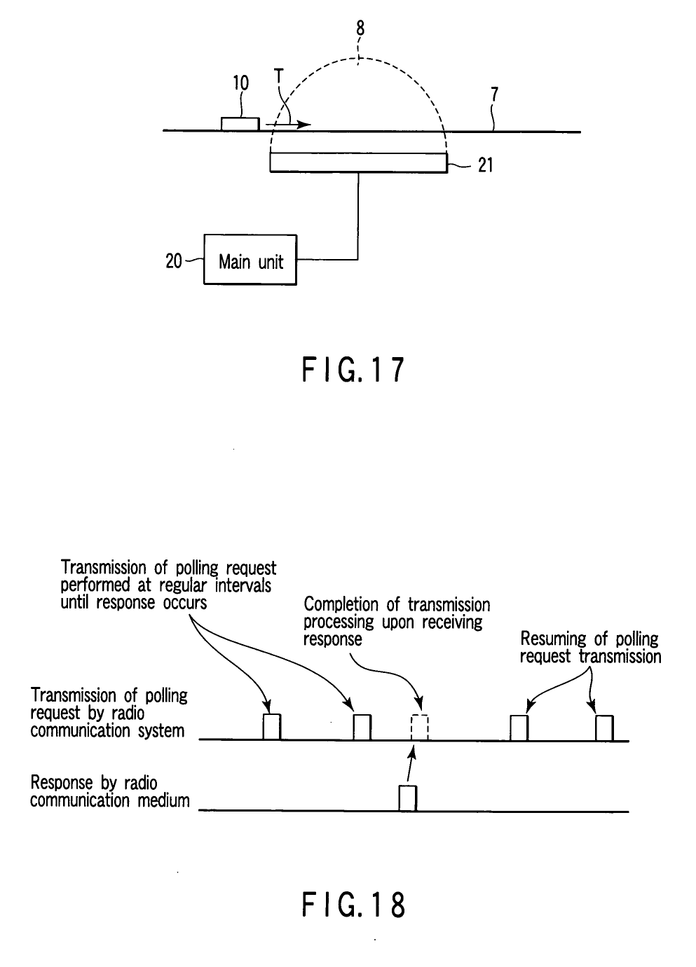

FIG. 1 is a schematic block diagram illustrating the configuration of a sheet processing device 300 according to the invention. In FIG. 1, a radio communication medium 10 is conveyed at a speed v [m/s] in a direction of arrow T through a conveyance path 7 included in the sheet processing device 300. In the embodiments, the radio communication medium 10 is conveyed, incorporated in (embedded in) a sheet (not shown) of, for example, a financial instrument or postal matter. Since the positional relationship between the main unit 20, antenna device 21 and conveyance path 7 of the sheet processing device 300 is similar to that shown in FIG. 17, no description is given of it. In FIGS. 1 and 17, like reference numbers denote like elements.

Firstly, the radio communication medium 10 will be described in detail.

The radio communication medium 10 comprises a communication antenna 11, modulating section 12, rectifying/demodulating section 13, and memory section 14. The modulating section 12, rectifying/demodulating section 13, and memory section 14 are formed of one IC chip 15.

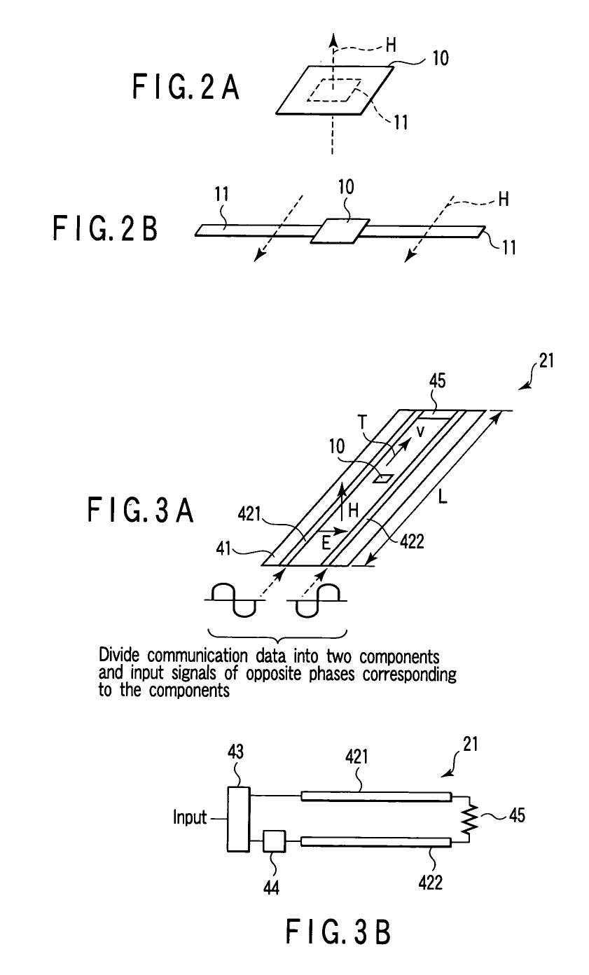

The radio communication medium 10 includes the type shown in FIG. 2A and that shown in FIG. 2B. The FIG. 2A type is, for example, an RF ID tag with a built-in flat, small loop antenna 11, in which the direction of a magnetic field H utilized is perpendicular to the flat surface of the antenna. The FIG. 2B type is, for example, an RF ID tag with an external antenna 11. In the description below, the radio communication medium 10 of the FIG. 2A type is employed. Arrows H in FIGS. 2A and 2B indicate the respective directions of the magnetic field H utilized by the antenna 11.

When the radio communication medium 10 conveyed enters the communication area 8 of the radio communication system, it receives, through the antenna 11, electromagnetic radiation (carrier waves) emitted from the antenna device 21 of the main unit 20. The electromagnetic radiation is rectified by the rectifying/demodulating section 13 and used as operation power for the radio communication medium 10.

The radio communication medium 10 becomes operable by the generated DC power and receives a polling request transmitted from the main unit 20 and superposed on carrier waves, thereby reading preset data from the memory section 14, and transmitting the data through the antenna 11. The transmission data is modulated by the modulating section 12. The polling request transmitted from the main unit 20 is defined as a stored-data transmission command to be issued to the radio communication medium 10. Further, the data read from the memory section 14 of the medium 10 is identification data for identifying a sheet on which the medium 10 is mounted. If the sheet is a sheet of valuable paper, the identification data includes the type of money.

The modulating section 12 comprises, for example, a diode switch, and is turned on and off in accordance with the state of the transmission data. For example, if the transmission data is “1”, the modulating section 12 is turned on, and the antenna 11 is terminated by the antenna impedance. As a result, the electromagnetic radiation from the main unit 20 is absorbed. In contrast, if the transmission data is “0”, the modulating section 12 is turned off, that is, the diode switch is opened, the end of the antenna 11 is also opened, and consequently the electromagnetic radiation from the main unit 20 is reflected.

The radio communication medium 10 transmits data to the main unit 20 by the backscattering method as described above.

The radio communication system will now be explained in detail. The radio communication system comprises the main unit 20 and antenna device 21. The main unit 20 has a circulator 22, mixers 23 and 24, oscillator 25, demodulating section 26, baseband processing section 27, host interface section 28, and communication control section 29. The main unit 20 is connected to a host apparatus 30 via the host interface section 28.

When a read command is transmitted from the host apparatus 30, such as the control device of the sheet processing apparatus 300 or host computer, it is supplied to the communication control section 29 via the host interface section 28, which in turn issues the read command to the baseband processing section 27.

The baseband processing section 27 edits the transmission data on the basis of the read command and, after filtering, transmits the transmission data as a baseband signal to the mixer 24. In the mixer 24, the baseband signal is subjected to amplitude shift keying (ASK) modulation. The ASK-modulated signal is superposed on carrier waves radiated from the antenna device 21 via the circulator 22, and thereby transmitted to the radio communication medium 10.

The transmitted electromagnetic radiation is reflected by the radio communication medium 10 by the backscattering method as described above. The signal reflected by the radio communication medium 10 is received by the antenna device 21, and input to the mixer 23, to which the same local frequency as that used during transmission thereof is input. The mixer 23 extracts the signal modulated by the radio communication medium 10.

The demodulating section 26 demodulates the signal extracted by the mixer 23 into data “1” or “0”, and transmits the data to the baseband processing section 27. The data extracted by the baseband processing section 27 is transmitted to the host apparatus 30 through the host interface section 28.

As described above, the radio communication system can read, in a noncontact manner, data stored in the memory section 14 of the radio communication medium 10.

The sheet processing apparatus 300 controls the conveyance processing of a sheet, based on the data read from the radio communication medium 10 by the radio communication system, i.e., the identification data of the sheet to which the radio communication medium 10 is attached. The conveyance processing includes, for example, the processing of collecting sheets in units of types thereof based on the identification data of the sheets.

As described above, when radio communication is performed using the radio communication medium 10 with a small loop antenna contained therein, with the medium 10 conveyed at a relatively high speed, it is necessary to generate a stable magnetic field H over a relatively long distance along the conveyance path of the medium 10. To this end, in the embodiment, the structure of the antenna device 21 of the radio communication system, which is used to generate the magnetic field H for powering the radio communication medium 10, has been contrived.

The antenna device 21 according to a first embodiment of the invention will be described in detail. The antenna device 21 has a structure suitable for the radio communication medium 10 with the small loop antenna shown in FIG. 2A. FIG. 3A schematically shows the structure of the antenna device 21, and FIG. 3B shows the circuitry of the antenna device 21.

The antenna device 21 is formed by, for example, providing two parallel transmission lines 421 and 422 on a dielectric base plate 41 using copper foil patterning, and electrically connecting them by a terminal section 45 provided therebetween.

The antenna device 21 is positioned near the conveyance path of the radio communication medium 10, such that the two transmission lines 421 and 422 are substantially parallel with the direction of conveyance of the medium 10 (sheet), and the medium 10 passes between the two transmission lines 421 and 422. As shown in FIG. 4, the transmission lines 421 and 422 cooperate to generate an electric field E directed from the transmission line 421 to the other transmission line 422, to thereby generate the magnetic field H necessary for the radio communication medium 10.

As shown in FIG. 3B, a signal supplied from the circulator 22 is divided into two equal components by an equal divider 43, such as a Wilkinson divider. One of the resultant components is directly sent to the transmission line 421. On the other hand, the other component is first sent to a phase shift section 44 as a phase shift circuit, where the phase of the component is shifted by 180°, and is then sent to the other transmission line 422. The equal divider 43 and phase shift section 44 function as the input circuit of the present invention. As mentioned above, the terminal section 45, which serves as a terminal circuit having a resistance equivalent to the characteristic impedance of the transmission lines 421 and 422, is connected between the ends of the transmission liens 421 and 422 opposite to the signal input ends thereof.

When a signal is input to the antenna device 21 constructed as above, the horizontal electric field E is generated between the transmission lines 421 and 422 as shown in FIGS. 3A and 4, whereby the magnetic field H perpendicular to the antenna surface (the surface of the plate 41) occurs between the transmission lines 421 and 422. Namely, since the impedance of the transmission line 421 matches that of the other transmission line 422, the signal components supplied to the lines 421 and 422 serve as progressive waves and form a uniform magnetic field H extending between the signal input side of the lines and the ends thereof.

Although in this embodiment, the signal components supplied to the transmission lines 421 and 422 have their phases shifted by 180° from each other, they may have their phases shifted by any degree if the uniformity of the magnetic field H is not regarded as important. In other words, the degree of uniformity of the magnetic field H can be changed by changing the phases of the signal components. However, to generate a most uniform magnetic field H, it is necessary to shift, from each other by 180°, the phases of the signal components supplied to the adjacent transmission lines. The same can be said of the case where three or more transmission lines are used.

In the above structure, when the radio communication medium 10 is moved at the speed v [m/s] through the conveyance path 7 between the transmission lines 421 and 422 in the direction indicated by arrow T in FIG. 3A, the uniform magnetic field H is exerted on the antenna 11 of the radio communication medium 10 within the zone extending along the entire length of the lines 421 and 422. As a result, the radio communication medium 10 is supplied with constant power by the radio communication system 20 for a preset time.

Thus, the antenna device 21 of the first embodiment enables the radio communication medium 10 to establish and maintain a reliable communication state while the medium 10 passes over the antenna device 21, and hence enables the medium 10 to normally execute and finish communication processing by the time when the medium 10 passes the antenna device 21.

Note that the antenna device 21 of the first embodiment is suitable when, in particular, communication is executed near the antenna device 21, utilizing power generated by inductive coupling between the device 21 and the radio communication medium 10, or if the radio communication medium 10 supplied with power from the antenna device 21 is an RF ID tag with a small built-in loop antenna.

Further, in the antenna device 21, the intensity of the magnetic field H occurring between the transmission lines 421 and 422 is varied when the distance between the lines 421 and 422 is varied. The distance therebetween is determined based on the magnetic field intensity required for the sheet processing apparatus 300.

The length L [m] of the transmission lines 421 and 422 shown in FIG. 3A is determined based on the conveyance speed v [m/s] of the radio communication medium 10 on the conveyance path 7, and the time t [s] required for communication processing between the radio communication system 20 and the radio communication medium 10. Namely, the following must be satisfied:
L≧v×t

Moreover, where the antenna device 21 of the first embodiment is used, if the processing time is increased because of an increase in the amount of data to be transmitted between the radio communication medium 10 and the radio communication system 20, or if the conveyance speed of the medium 10 is increased, these can be dealt with simply by increasing the length of the transmission lines 421 and 422.

An antenna device 121 according to a second embodiment of the invention will be described. The antenna device 121 is the same in basic structure as that of the first embodiment.

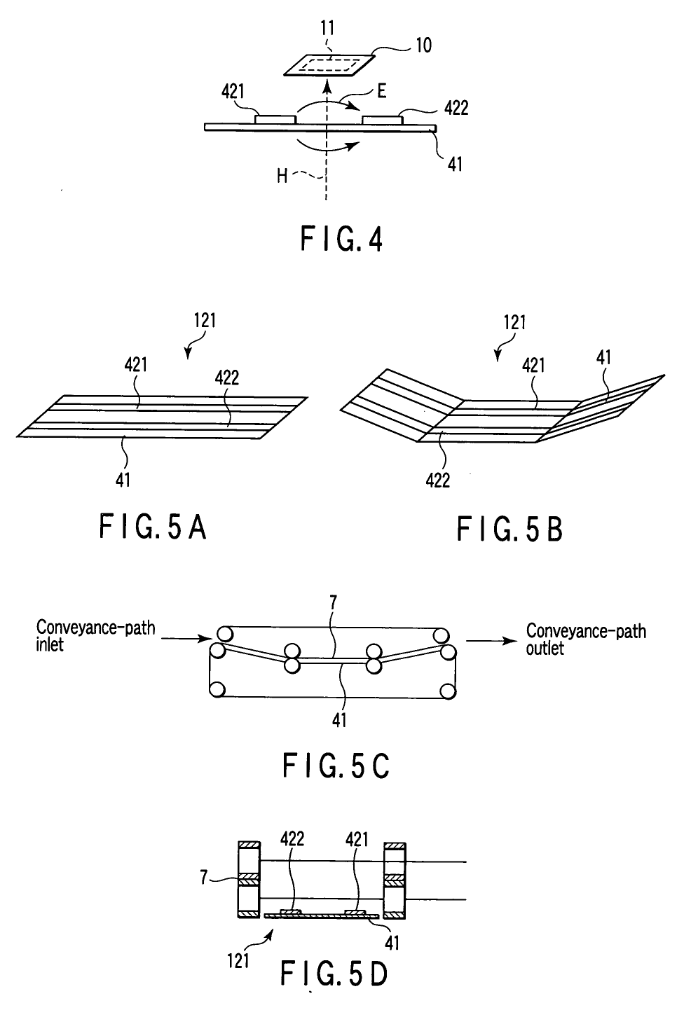

FIG. 5A schematically shows the essential part of the antenna device 121. If the conveyance path 7 is curved at the position corresponding to the antenna device 121, it is necessary to angle the antenna device 121 along the curved conveyance path 7. Namely, to establish stable communication over a long range, it is necessary to provide the transmission lines of the antenna device 121 near the radio communication medium 10 conveyed on the conveyance path. If a rigid plate 41 is used as the base member of the antenna device 121 as in the first embodiment, it is difficult to provide the antenna device along the curved conveyance path 7.

In light of this, in the second embodiment, the base plate 41 on which the transmission lines 421 and 422 are provided is formed of, for example, a polyimide film, and the transmission lines 421 and 422 are formed of a deformable material, such as copper foil. The base plate 41 is angled in accordance with the shape of the conveyance path 7 as shown in FIG. 5B, and is located close to the conveyance path 7 as shown in FIG. 5C. The distance between the conveyance path 7 and the antenna device 121 is set to a value that enables the radio communication medium 10 conveyed on the conveyance path 7 to receive power that can drive the medium 10. Accordingly, as shown in FIG. 5D, the antenna device 121 is located between two pairs of conveyance belts at a position close to the conveyance path 7.

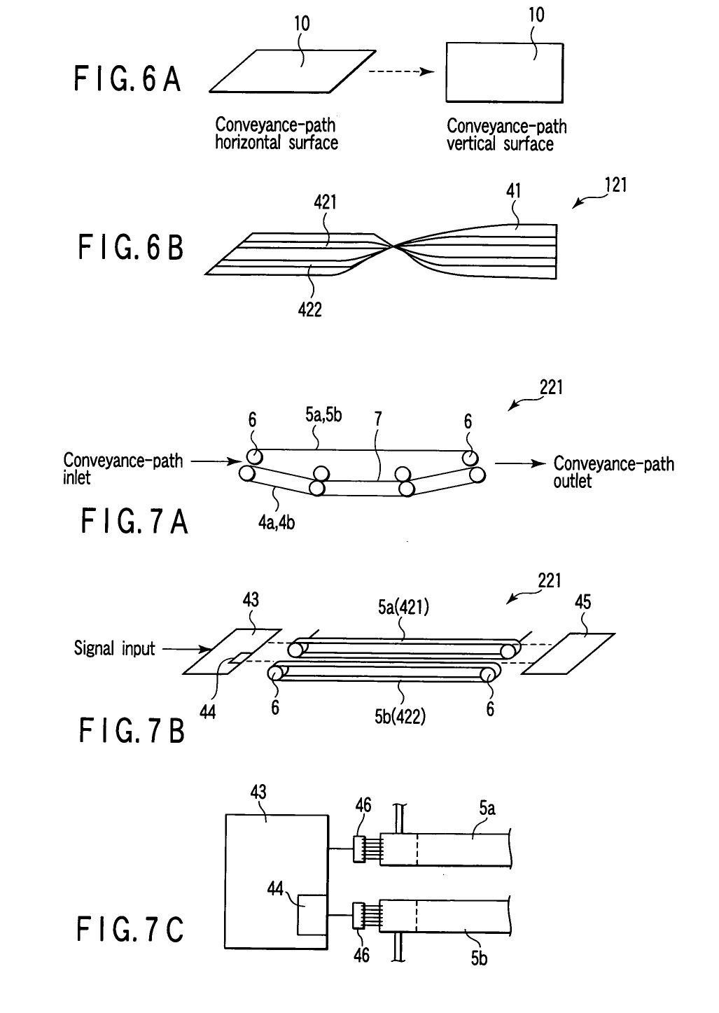

As described above, the antenna device 121 of the second embodiment can be appropriately positioned near the curved conveyance path 7 as shown in FIG. 5C. Further, if the conveyance path 7 is twisted as shown in FIG. 6A such that it conveys the radio communication medium 10 firstly horizontally and then vertically, the antenna device 121 can be twisted as shown in FIG. 6B in accordance with the twisted path 7. As a result, the antenna device 121 can be provided near and parallel to the conveyance path 7. Thus, the antenna device 121 of the second embodiment can be incorporated in various sheet processing apparatuses 300 that include conveyance paths 7 of different shapes. Namely, there are no limitations on the location of the antenna device 121.

The transmission lines 421 and 422 on the device 121 are positioned substantially parallel to the conveyance path 7 and hence with the surface of the radio communication medium 10 conveyed on the path 7, regardless of whether the antenna device 121 is angled as shown in FIG. 5B, or twisted as shown in FIG. 6B.

An antenna device 221 according to a third embodiment of the invention will be described.

The antenna device 221 is characterized in that conveyance belts 5a and 5b for conveying the radio communication medium 10 are made conductive and made to function as the transmission lines 421 and 422. As shown in FIG. 7A, the conveyance path 7 is defined by two endless conveyance belts 4a and 4b and two conveyance belts 5a and 5b. In the second embodiment, as shown in FIG. 7B, the two conveyance belts 5a and 5b that serve as the upper surfaces of the conveyance path 7 are made conductive. Alternatively, the conveyance belts 4a and 4b that serve as the lower surfaces of the conveyance path 7 may be made conductive.

More specifically, as shown in FIG. 7B, the two conveyance belts 5a and 5b that define the upper surface of the conveyance path 7 are tensioned between a plurality of rollers 6, formed of conductive members, such as steel belts, and used as the transmission lines 421 and 422.

As shown in FIG. 7B, a signal supplied from the circulator 22 is divided into two equal components by the equal divider 43. One of the resultant components is directly sent to one end of the conveyance belt 5a (transmission line 421). On the other hand, the other component is first sent to the phase shift section 44, where the phase of the component is shifted by 180°, and is then sent to one end of the other conveyance belt 5b (transmission line 422). Further, the terminal section 45 is connected to the other ends of the conveyance belts 5a and 5b.

The equal divider 43, phase shift section 44 and terminal section 45 may be electrically connected to the conveyance belts 5a and 5b via the shafts of the rollers 6, if the rollers 6 are formed of conductive members. Alternatively, they may be electrically connected to the belts 5a and 5b via conductive brushes 46 that contact the belts, as shown in FIG. 7C.

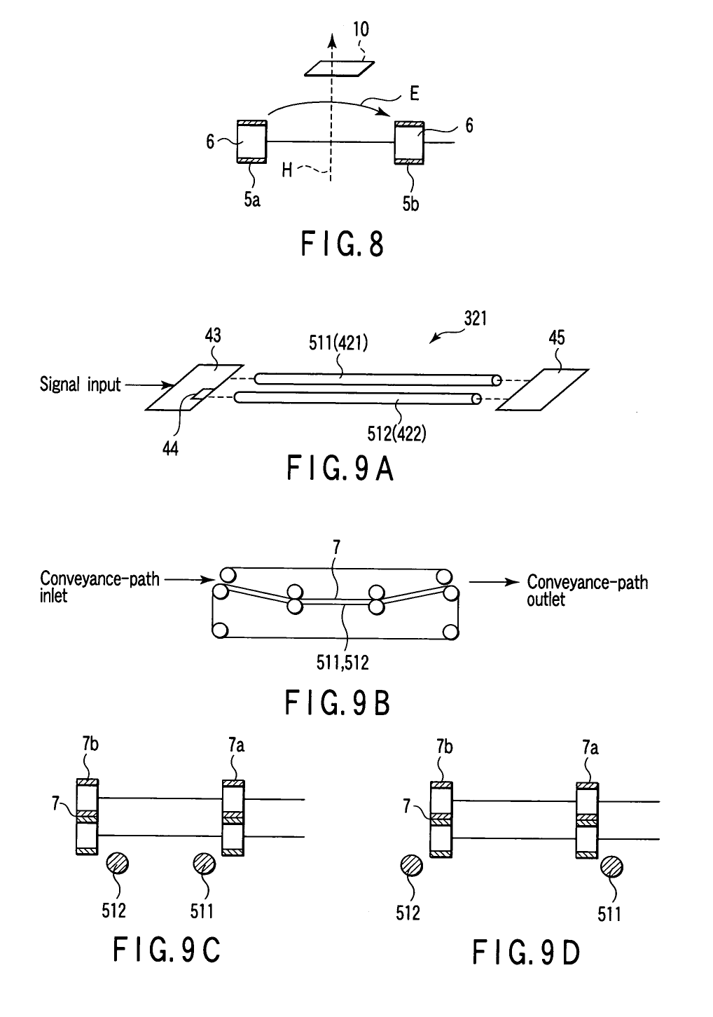

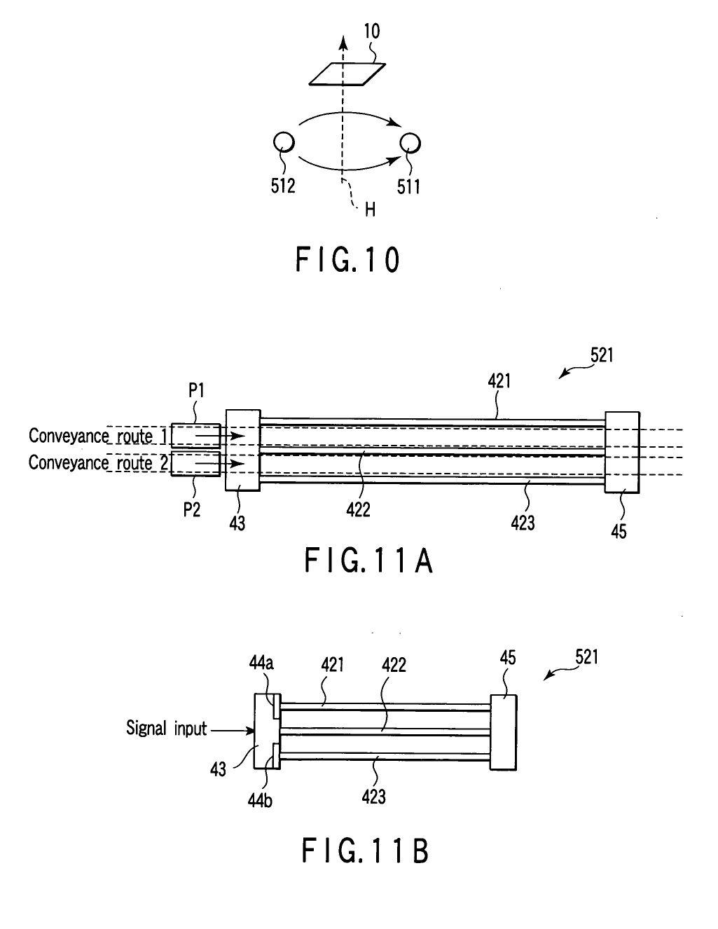

As described above, in the third embodiment, the conveyance belts 5a and 5b are made to function as the transmission lines 421 and 422, respectively, and a magnetic field H is generated between the conveyance belts 5a and 5b perpendicularly with respect to the surface of the radio communication medium 10 conveyed, as is shown in FIG. 8. Accordingly, in the third embodiment, when the radio communication medium 10 incorporated in a sheet passes between the conveyance belts 5a and 5b, it receives power and accesses the radio communication system, as in the first and second embodiments. In particular, in the third embodiment, the radio communication medium 10 can be positioned closer to the transmission lines 421 and 422 than in the first and second embodiments, thereby more reliably performing communication.

An antenna device 321 according to a fourth embodiment of the invention will be described.

The antenna device 321 is characterized in that the two transmission lines 421 and 422 are formed of conductive wires, such as copper wires, 511 and 512, as shown in FIG. 9A. The conductive wires 511 and 512 can also be angled in accordance with the shape of the conveyance path 7, like the antenna device 121 of the second embodiment. Namely, the transmission lines 421 and 422 can be angled along the curved conveyance path 7 as shown in FIG. 9B. Further, note that in the fourth embodiment, the conductive wires 511 and 512 are angled in accordance with the shape of the conveyance path 7, then positioned close to the path 7, and fixed in position by an insulation material, such as a resin, thereby fixing the antenna device 321.

A signal supplied from the circulator 22 is divided into two equal components by the equal divider 43. One of the resultant components is directly sent to one end of the conductive wire 511 (transmission line 421). The other component is first sent to the phase shift section 44, where the phase of the component is shifted by 180°, and is then sent to one end of the other conductive wire 512 (transmission line 422). Further, the terminal section 45 is connected to the other ends of the conveyance wires 511 and 512.

The conductive wires 511 and 512 may be located inside a pair of conveyance belts 7a and 7b providing the conveyance path 7 as shown in FIG. 9C, or outside the belts 7a and 7b as shown in FIG. 9D. The distance between the transmission lines 421 and 422 can be made shorter to thereby make higher the intensity of the magnetic field H exerted on the radio communication medium 10, in the structure of FIG. 9C than in the structure of FIG. 9D. However, the locations of the conductive wires 511 and 512 are determined in light of the convenience of layout of the wires.

As described above, in the antenna device 321 of the fourth embodiment, the conductive wires 511 and 512 are made to function as the transmission lines 421 and 422, respectively, and the magnetic field H is generated between the two conductive wires 511 and 512 perpendicularly with respect to the surface of the radio communication medium 10 conveyed. Accordingly, in the fourth embodiment, when the radio communication medium 10 incorporated in a sheet passes between the conductive wires 511 and 512, it receives power and accesses the radio communication system, as in the first to third embodiments.

An antenna device 521 according to a fifth embodiment of the invention will be described. The antenna device 521 is characterized in that a transmission line 423 is employed in addition to the two transmission lines 421 and 422. In the other structures, the antenna device 521 is substantially identical to the antenna device 21 of the first embodiment.

As shown in FIG. 11A, the antenna device 521 includes three transmission lines 421, 422 and 423 parallel to each other, therefore can be incorporated into an apparatus for conveying two sheets parallel to each other and simultaneously processing them. The antenna device 521 can be angled or twisted as in the second to fourth embodiments. Thus, in all embodiments, the number of transmission lines can be increased to convey a plurality of sheets parallel to each other and simultaneously process them.

As mentioned above, the antenna device 521 is incorporated in a sheet processing apparatus for simultaneously conveying and processing two sheets P1 and P2 using two conveyance routes 1 and 2, and includes the three transmission lines 421, 422 and 423 extending in the conveyance direction of sheets. For example, the antenna device 521 is formed by patterning copper foil into the three transmission lines 421, 422 and 423 on the surface of the base plate 41, and electrically connecting the ends of the lines by the terminal section 45.

As shown in FIG. 11B, a signal supplied from the circulator 22 is divided into three equal components by the equal divider 43. One of the resultant components is directly sent to one end of the central transmission line 422. The respective remaining components are first sent to phase shift sections 44a and 44b, where their phases are shifted by 180°, and are then sent to respective ends of the other two transmission lines 421 and 423.

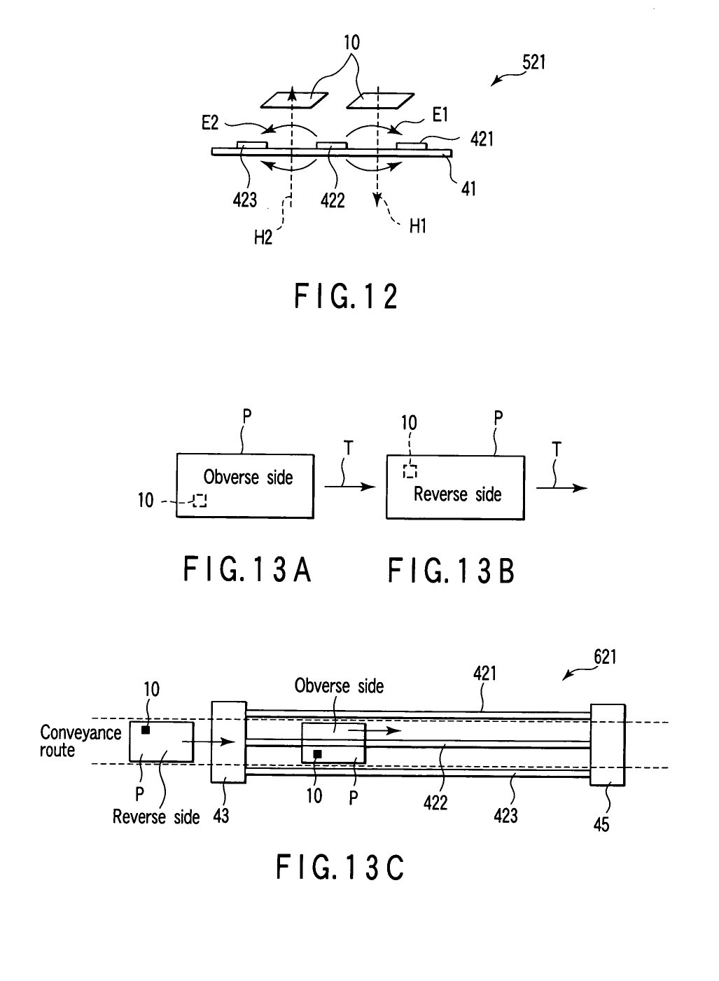

At this time, as shown in FIG. 12, magnetic fields H1 and H2 are formed between the transmission lines 421 and 422 and between the transmission lines 422 and 423 perpendicularly with respect to the surface of the radio communication medium 10 conveyed. When the sheets P1 and P2 with the respective radio communication medium pieces 10 incorporated therein pass between the transmission lines 421 and 422 and between the transmission lines 422 and 423, respectively, as shown in FIG. 11A, the radio communication medium pieces 10 receive power and access the radio communication system. Thus, the antenna device 521 of the fifth embodiment enables two sheets P1 and P2 to be simultaneously conveyed and processed.

Although in the case of FIG. 11B, two phase shift sections 44a and 44b are provided for the transmission lines 421 and 423 located at the opposite ends, only a single phase shift section 44 may be provided for the central transmission line 422. It is sufficient if each pair of adjacent ones of the transmission lines are shifted in phase by 180°. Further, as mentioned above, it is not always necessary to shift the phases of the adjacent transmission lines by 180°, but the degree of shift may be set to an arbitrary value.

Moreover, if the antenna device 521 is applied to a sheet processing apparatus for conveying three or more sheets parallel to each other and simultaneously processing them, it is necessary to increase the number of transmission lines accordingly. It is also necessary to prepare an appropriate equal divider corresponding to the number of the resultant transmission lines, and to connect respective phase shift sections to every second transmission line so as to shift, by 180°, the phases of respective signal components sent to every second transmission line.

An antenna device 621 according to a sixth embodiment of the invention will be described.

In each of the above-described embodiments, it is assumed that the lateral position of the radio communication medium 10 on the conveyance path is kept constant. Actually, however, the radio communication medium 10 is not always provided on the center of a sheet. For example, when the radio communication medium 10 is incorporated in one corner of each sheet P, some sheets may be conveyed with their obverse sides directed upward, as shown in FIG. 13A, and other sheets be conveyed with their reverse side directed upward, as shown in FIG. 13B. Thus, the lateral position may well differ between radio communication medium pieces 10.

When the lateral position differs between radio communication medium pieces 10, there may be a case where the radio communication medium 10 is positioned outside the communication area 8, and cannot perform communication. To avoid such a case, the antenna device 621 of the sixth embodiment employs three parallel transmission lines 421, 422 and 423, like the fifth embodiment. Although the antenna device 621 has substantially the same structure as the antenna device 521, it differs in intended purpose.

Namely, in the antenna device 621 of the sixth embodiment, each sheet P is conveyed so that the center of each sheet P passes over the central transmission line 422 included in the three transmission lines 421 to 423, as shown in FIG. 13C, which enables reliable communication to be always performed regardless of the position of the radio communication medium 10 on each sheet P. That is, even if some sheets are conveyed with their obverse sides directed upward, as shown in FIG. 13A, and other sheets are conveyed with their reverse side directed upward, as shown in FIG. 13B, their radio communication medium pieces 10 pass between the transmission lines 421 and 422 or between the transmission lines 422 and 423. As a result, all radio communication medium pieces 10 can perform reliable communication.

Also in the sixth embodiment, if the radio communication medium pieces 10 are mounted on three or more different portions of sheets, it is sufficient if the number of transmission lines is increased accordingly, an appropriate equal divider corresponding to the number of the resultant transmission lines is prepared, and respective phase shift sections are connected to every second transmission line so as to shift, by 180°, the phases of respective signal components sent to every second transmission line. In this case, the position of each radio communication medium 10 may be detected before each sheet P is sent to the antenna device 621, and an input signal may be sent only to the transmission line corresponding to the detected position.

An antenna device 721 according to a seventh embodiment of the invention will be described.

Like the antenna device 221 of the third embodiment, the antenna device 721 is characterized in that the conveyance belts 4a and 4b are formed of conductive members, such as steel belts, and made to function as the transmission lines 421 and 422. The conveyance belts 4a and 4b are included in the conveyance belts 4a, 4b, 5a and 5b defining the conveyance path 7 for conveying each sheet with the radio communication medium 10, and define the lower side of the conveyance path 7. In the third embodiment, power is supplied to the conveyance belts 5a and 5b via the conductive brushes 46 as shown in FIG. 7C. In contrast, the antenna device 721 of the seventh embodiment has a structure for supplying power to each of the conveyance belts 5a and 5b in a noncontact manner.

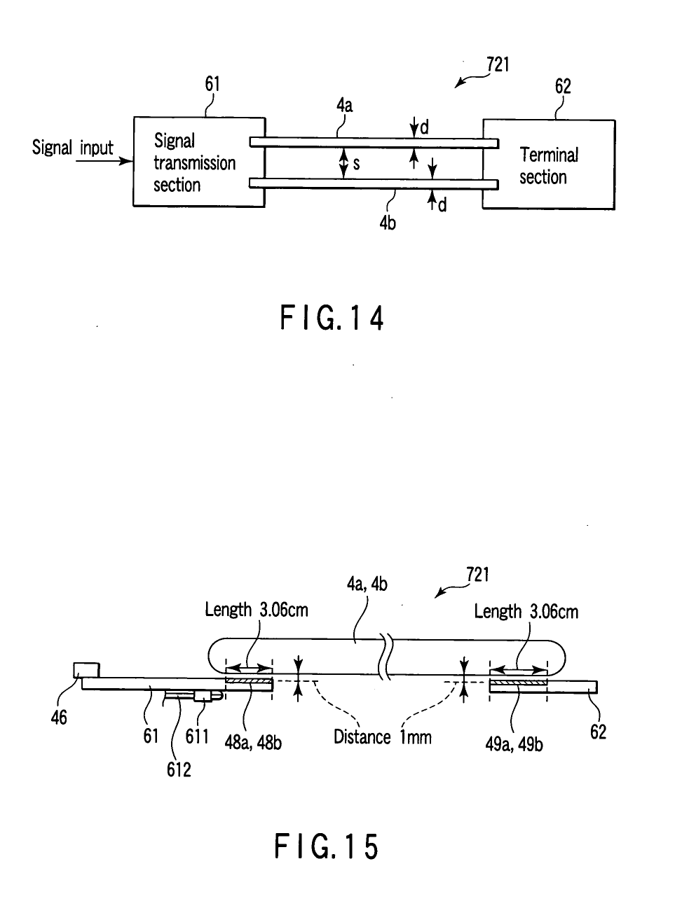

As shown in FIG. 14, in the antenna device 721, the distance between the conveyance belts 4a and 4b is set to s [mm] that enables a magnetic field H of an intensity required by the radio communication medium 10 passing between the belts 4a and 4b to be generated. Further, the width of each conveyance belt 4a, 4b is set to d [mm]. The smaller the distance s between the conveyance belts 4a and 4b, the lower the intensity of the magnetic field H generated by the antenna device 721.

As shown in FIG. 15, a signal transmission section 61 is provided, overlapping with the carry-in ends of the conveyance belts 4a and 4b in a noncontact manner. The length, over which the signal transmission section 61 overlaps with the carry-in ends of the conveyance belts 4a and 4b, is determined from the frequency of a signal input to the antenna device 721. Also in the antenna device 721, signals shifted by 180° from each other are supplied to the adjacent conveyance belts 4a and 4b (transmission lines 421 and 422).

The length, over which the signal transmission section 61 overlaps with the carry-in ends of the conveyance belts 4a and 4b, is set to, for example, a quarter of the wavelength of the signal supplied to the conveyance belts 4a and 4b. Since the seventh embodiment employs a transmission signal with a frequency of 2.45 GHz, one wavelength is 12.24 cm, therefore the quarter-wavelength is 3.06 cm. Accordingly, in the seventh embodiment, the length, over which the signal transmission section 61 overlaps with the carry-in ends of the conveyance belts 4a and 4b, is set to 3.06 cm.

Similarly, a terminal section 62 is provided, overlapping with the carry-out ends of the conveyance belts 4a and 4b in a noncontact manner. The signal transmission section 61 and terminal section 62 function as a signal circuit in the invention. The length, over which the terminal section 62 overlaps with the carry-out ends of the conveyance belts 4a and 4b, is also set to a quarter of the wavelength of the signal supplied to the antenna device 721. Namely, in the seventh embodiment, the length, over which the terminal section 62 overlaps with the carry-out ends of the conveyance belts 4a and 4b, is also set to 3.06 cm.

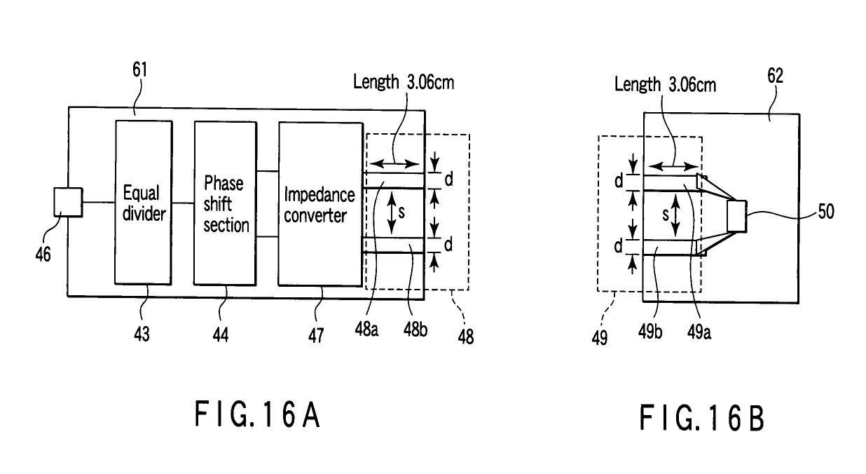

As shown, for example, in FIG. 16A, the signal transmission section 61 includes a connector 46 connected to a signal transmission line lead from the circulator 22, equal divider 43 for distributing, to the conductive conveyance belts 4a and 4b, a signal supplied from the connector 46, phase shift section 44 for shifting the phase of one of the signals from the equal divider 43, impedance converter 47 and inductance coupling section 48.

The inductance coupling section 48 has two conductors 48a and 48b for transmitting, to the conveyance belts 4a and 4b in a noncontact manner, two signal components of different phases output from the phase shift section 44. The conductors 48a and 48b are arranged with the same distance s [mm] as that between the conveyance belts 4a and 4b, and have the same width d [mm]. The conductors 48a and 48b are conductive patterns formed by printing. In the seventh embodiment, The length of the conductors 48a and 48b is set to 3.06 cm that is equal to the length, over which the inductance coupling section 48 overlaps with the conveyance belts 4a and 4b. Since the conductors 48a and 48b of the inductance coupling section 48 differ in impedance from the lines of the phase shift section 44, the impedance converter 47 is interposed therebetween.

As shown in FIG. 15, the conductors 48a and 48b of the inductance coupling section 48 oppose the conveyance belts 4a and 4b in a noncontact manner at the carry-in ends of the belts, respectively. In this state, it is desirable to set the distance between the conveyance belts 4a, 4b and the conductors 48a, 48b to a value that enables maximum power to be supplied from the signal transmission section 61 to the conveyance belts 4a and 4b as a result of the coupling of the signal transmission section 61 and conveyance belts 4a and 4b. In this embodiment, the distance is set to 1 mm.

On the other hand, as shown in FIG. 16B, the terminal section 62 includes a resistor 50 connected to, for example, another inductance coupling section 49 that is connected, in a noncontact manner, to the conveyance belts 4a and 4b. The resistor 50 is also connected to conductors 49a and 49b incorporated in the inductance coupling section 49, and has a resistance equivalent to the impedance of the conveyance belts 4a and 4b. The two conductors 49a and 49b of the inductance coupling section 49 are arranged with the same interval s [mm] therebetween as the two conveyance belts 4a and 4b, and have the same width d [mm] as the belts 4a and 4b and the length determined from the frequency of a signal supplied to the conveyance belts 4a and 4b. The conductors 49a and 49b are printed conductive patterns.

In the seventh embodiment, the length of the conductors 49a and 49b of the inductance coupling section 49 is set to a quarter of the wavelength of the signal supplied to the conveyance belts 4a and 4b, i.e., 3.06 cm, like the belts 4a and 4b.

As shown in FIG. 15, at the carry-out ends of the conveyance belts 4a and 4b, the conductors 49a and 49b of the inductance coupling section 49 oppose the conveyance belts 4a and 4b in a noncontact manner, respectively. In the seventh embodiment, the distance between the conveyance belts 4a, 4b and the conductors 49a, 49b is also set to 1 mm, as in the signal transmission section 61.

In the above structure, a signal supplied from the circulator 22 is transmitted to the signal transmission section 61 via the connector 46, and divided into two components by the equal divider 43. One of the two components is directly sent to one end of the conveyance belt 4a via the impedance converter 47 and conductor 48a. On the other hand, the other component is first sent to the phase shift section 44, where its phase is shifted by 180°, and is then sent to one end of the other conveyance belt 4b via the impedance converter 47 and conductor 48b.

Since the conductors 48a and 48b of the signal transmission section 61 oppose the carry-in ends of the conveyance belts 4a and 4b with the distance of 1 mm interposed therebetween, over a quarter of the wavelength of the signal transmitted, maximum power is supplied from the signal transmission section 61 to the conveyance belts 4a and 4b as a result of their coupling.

Similarly, at the terminal section 62 for terminating the transmission paths to prevent stationary waves from occurring in the transmission paths formed by the conductive conveyance belts 4a and 4b, the conductors 49a and 49b oppose each other with the distance of 1 mm interposed therebetween, over a quarter of the wavelength of the signal transmitted. Accordingly, maximum power is supplied from the conveyance belts 4a and 4b to the terminal section 62 as a result of their coupling. The resistor 50 of the terminal section 62 absorbs the supplied maximum power. Thus, the terminal section 62 functions as the transmission line terminal of the conveyance belts 4a and 4b, namely, the terminal section 62 terminates the transmission lines.

In the antenna device 721 of the seventh embodiment, the conveyance belts 4a and 4b are supplied with power in a noncontact manner by the signal transmission section 61 of the main unit 20, while rotating at high speed for conveying sheets, whereby a magnetic field H is formed between the conveyance belts 4a and 4b perpendicularly with respect to the surface of the radio communication medium 10. When the radio communication medium 10 incorporated in each sheet passes between the conveyance belts 4a and 4b, it receives power and accesses the main unit 20.

As described above, in the seventh embodiment, the conveyance belts 4a and 4b for conveying sheets with radio communication at a relatively high speed are formed of a conductive material, and power is supplied from the signal transmission section 61 to the conductive conveyance belts 4a and 4b in a noncontact manner, and is terminated by the terminal section 62 provided in a noncontact manner. As a result, the same advantage as acquired from the antenna device 221 of the third embodiment can be acquired from the antenna device 721, and the signal transmission section 61 and terminal section 62 can be provided out of contact with the conveyance belts 4a and 4b, which is free from such a disadvantage as abrasion due to sliding contact of conductive brushes with the contacts of the conveyance belts 4a and 4b, even if the belts are rotated at high speed. Namely, the antenna device 721 of the seventh embodiment enables stable communication processing to be executed for a long time.

Further, since the length, over which the inductance coupling section 48 of the signal transmission section 61 overlaps with the conveyance belts 4a and 4b, is set to a quarter of the wavelength of the transmission signal, maximum power can always be supplied to the belts. This extremely facilitates the incorporation of the antenna device 721 of the radio communication system into the sheet conveyance path.

Although in the seventh embodiment, length, over which the inductance coupling section 48 of the signal transmission section 61 overlaps with the conveyance belts 4a and 4b, is set to a quarter of the wavelength of the transmission signal, an adjustment mechanism may be provided which adjusts the position of the signal transmission section 61 to make the length of the overlapping members longer or shorter than the quarter wavelength, as is shown in, for example, FIG. 15. The adjustment mechanism shown in FIG. 15 comprises a slider 611 fixed on the rear surface of the signal transmission section 61, and a rail 612 supporting the slider 611 so that the slider can slide in the longitudinal direction of the conveyance belts 4a and 4b. After the length, over which the signal transmission section 61 overlaps with the conveyance belts 4a and 4b, is adjusted, the adjustment mechanism is fixed by, for example, a screw. Using the adjustment mechanism, the transmission amount of power can be adjusted. Further, using the adjustment mechanism, the intensity of the magnetic field H formed by the conveyance belts 4a and 4b can be adjusted, the communication distance to the radio communication medium 10 can be adjusted, and unnecessary radiation from the main unit 20 can be minimized.

Similarly, if an adjustment mechanism (not shown) for adjusting the distance between the conductors 48a and 48b of the signal transmission section 61 is employed, the distance s between those portions of the conductors 48a and 48b that overlap with the conveyance belts 4a and 4b can be increased or decreased, using this mechanism, thereby changing the transmission amount of power. As a result, the intensity of the magnetic field H can be adjusted, the communication distance to the radio communication medium 10 can be adjusted, and unnecessary radiation from the main unit 20 can be minimized.

Also, although in the seventh embodiment, two pairs of conveyance belts are used as the conveyance belts for conveying sheets, the invention is also applicable to an apparatus that employs three or more pairs of conveyance belts.

In addition, although in the above-described embodiments, to-be-processed sheets are, specifically, securities (including banknotes), they also include card mediums such as bankcards and credit cards.

As described above, in the antenna device 21 of the first embodiment, a plurality of transmission lines are provided parallel to each other along the conveyance direction of the radio communication medium 10, and a magnetic field H is generated between the transmission lines perpendicularly with respect to the surface of the radio communication medium 10 conveyed, thereby enabling communication with the radio communication medium 10. Accordingly, if the antenna device 21 is mounted near and along a conveyance path for sequentially processing, at a high speed, sheets with respective radio communication medium pieces 10 embedded therein, it can generate a uniform magnetic field H over a relatively long distance in the conveyance direction of the medium pieces 10. As a result, the radio communication medium 10 can receive uniform power and perform reliable communication processing when it exists in the communication area 8 of the radio communication system.

Further, if the transmission lines 421 and 422 are extended, they can easily deal with an increase in processing time due to an increase in the amount of data to be transmitted between the radio communication medium and the radio communication system, or deal with an increase in conveyance speed.

The antenna device 121 of the second embodiment and the antenna device 321 of the fourth embodiment can provide the same advantage as the antenna device 21 of the first embodiment. In addition, since the antenna devices of the second and fourth embodiment can be deformed, they can easily be mounted even if the conveyance path has a complex configuration.

The antenna device 221 of the third embodiment and the antenna device 721 of the seventh embodiment can provide the same advantage as the antenna device 21 of the first embodiment. In addition, since in these antenna devices, the conveyance belts that define a conveyance path for the radio communication medium 10 are formed of a conductive material to also serve as transmission lines, the antenna devices can be easily mounted even if the conveyance path has a complex configuration. In particular, the antenna device 721 of the seventh embodiment employs a structure in which the conveyance belts are supplied with power in a noncontact manner and terminated also in a noncontact manner. Accordingly, the antenna device 721 is free from degradation of contacts due to abrasion, and can perform reliable communication processing for a long time.

The antenna device 521 of the fifth embodiment can provide the same advantage as the antenna device 21 of the first embodiment. In addition, since in the antenna device 521, three or more transmission lines are provided parallel to each other to define a plurality of communication areas, the antenna device 521 is applicable to a processing scheme in which a plurality of radio communication medium pieces 10 are conveyed parallel to each other.

The antenna device 621 of the sixth embodiment can provide the same advantage as the antenna device 21 of the first embodiment. In addition, since in the antenna device 621, three or more transmission lines are provided parallel to each other to define a plurality of communication areas, the antenna device 621 enables a plurality of radio communication medium pieces 10 to execute reliable communication even if the medium pieces 10 are positioned at discrete positions between sheets.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

For instance, the sheets employed in the above-described embodiments may include card mediums, such as bankcards, credit cards, etc., as well as sheets of valuable securities (including banknotes).

Furthermore, although in the above-described embodiments, the antennas (transmission lines) arranged parallel to each other are elongated lines extending in the conveyance direction, they are not limited to such lines.

Also, the term “parallel” or “perpendicular” used above does not mathematically strictly mean “parallel” or “perpendicular”, but allows some deviations resulting from variations in manufacture or installment.

What is claimed is:

1. A radio communication system including:
an antenna device which generates a magnetic field to a radio communication medium conveyed through a conveyance path, the magnetic field passing through the radio communication medium; and
a main unit which transmits and receives signals via the antenna device to and from the radio communication medium conveyed through the conveyance path, thereby performing communication with the radio communication medium,
and wherein
the antenna device comprises a plurality of transmission lines provided parallel to each other along the conveyance path, and a signal circuit which divides, into a plurality of components, a signal from the main unit, shifts phases of the components from each other, and supplies the resultant components to the respective transmission lines.

2. The radio communication system according to claim 1, wherein the signal circuit includes:
a signal dividing circuit which divides, into the components, the signal from the main unit and supplies the components to the transmission lines;
a phase shift circuit which makes the phases of the components shift from each other such that the components of different phases are supplied to adjacent ones of the transmission lines, and then supplies the resultant components to the transmission lines; and
a terminal circuit which terminates the transmission lines.

3. The radio communication system according to claim 2, wherein the terminal circuit has a resistance equivalent to a characteristic impedance of the transmission lines.

4. The radio communication system according to claim 2, wherein the phase shift circuit shifts, by 180°, the phases of the components to be supplied to the adjacent ones of the transmission lines.

5. The radio communication system according to claim 1, wherein the transmission lines are formed of members deformable along the conveyance path.

6. The radio communication system according to claim 1, wherein the transmission lines are formed of conductive conveyance belts which convey the radio communication medium along the conveyance path.

7. The radio communication system according to claim 6, wherein the signal circuit includes:
a signal transmission section provided overlapping with carry-in ends of the conveyance belts in a noncontact manner; and
a terminal section provided overlapping with carry-out ends of the conveyance belts in a noncontact manner.

8. The radio communication system according to claim 7, wherein a length, over which the signal transmission section overlaps with the carry-in ends of the conveyance belts, and a length, over which the terminal section overlaps with the carry-out ends of the conveyance belts, are determined from a wavelength of a signal supplied to the conveyance belts via the signal circuit.

9. The radio communication system according to claim 8, wherein the length is a quarter of the wavelength of the signal.

10. The radio communication system according to claim 8, further comprising an adjustment mechanism which adjusts the length.

11. An antenna device for a radio communication system which performs radio communication by transmitting and receiving signals to and from a radio communication medium conveyed through a conveyance path, comprising:
a plurality of transmission lines provided parallel to each other along the conveyance path; and
a signal circuit which divides, into a plurality of components, a signal from the main unit, shifts phases of the components from each other, and supplies the resultant components to the respective transmission lines.

12. The antenna device according to claim 11, wherein the signal circuit includes:
a signal dividing circuit which divides, into the components, the signal from the main unit and supplies the components to the transmission lines;
a phase shift circuit which makes the phases of the components shift from each other such that the components of different phases are supplied to adjacent ones of the transmission lines, and then supplies the resultant components to the transmission lines; and
a terminal circuit which terminates the transmission lines.

13. The antenna device according to claim 12, wherein the terminal circuit has a resistance equivalent to a characteristic impedance of the transmission lines.

14. The antenna device according to claim 12, wherein the phase shift circuit shifts, by 180° , the phases of the components to be supplied to the adjacent ones of the transmission lines.

15. The antenna device according to claim 11, wherein the transmission lines are formed of members deformable along the conveyance path.

16. The antenna device according to claim 11, wherein the transmission lines are formed of conductive conveyance belts which convey the radio communication medium along the conveyance path.

17. The antenna device according to claim 16, wherein the signal circuit includes:
a signal transmission section provided overlapping with carry-in ends of the conveyance belts in a noncontact manner; and
a terminal section provided overlapping with carry-out ends of the conveyance belts in a noncontact manner.

18. The antenna device according to claim 17, wherein a length, over which the signal transmission section overlaps with the carry-in ends of the conveyance belts, and a length, over which the terminal section overlaps with the carry-out ends of the conveyance belts, are determined from a wavelength of a signal supplied to the conveyance belts via the signal circuit.

19. The antenna device according to claim 18, wherein the length is a quarter of the wavelength of the signal.

20. The antenna device according to claim 18, further comprising an adjustment mechanism which adjusts the length.

21. A sheet processing apparatus for conveying a sheet provided with a radio communication medium storing identification data, reading the identification data from the radio communication medium, and processing the sheet based on the read identification data, comprising:
an antenna device which generates a magnetic field to a radio communication medium conveyed through a conveyance path, the magnetic field passing through the radio communication medium; and
a main unit which transmits and receives signals via the antenna device to and from the radio communication medium conveyed through the conveyance path, thereby performing communication with the radio communication medium,
wherein
the antenna device comprises a plurality of transmission lines provided parallel to each other along the conveyance path, and a signal circuit which divides, into a plurality of components, a signal from the main unit, shifts phases of the components from each other, and supplies the resultant components to the respective transmission lines.

22. The sheet processing apparatus according to claim 21, wherein the signal circuit includes:
a signal dividing circuit which divides, into the components, the signal from the main unit and supplies the components to the transmission lines;
a phase shift circuit which makes the phases of the components shift from each other such that the components of different phases are supplied to adjacent ones of the transmission lines, and then supplies the resultant components to the transmission lines; and
a terminal circuit which terminates the transmission lines.

23. The sheet processing apparatus according to claim 21, wherein the transmission lines are formed of conductive conveyance belts which convey the radio communication medium along the conveyance path.

24. The sheet processing apparatus according to claim 23, wherein the signal circuit includes:
a signal transmission section provided overlapping with carry-in ends of the conveyance belts in a noncontact manner; and
a terminal section provided overlapping with carry-out ends of the conveyance belts in a noncontact manner.
